(19) United States
(12) Patent Application Publication
(10) Pub. No.: US 2026/0323758 A1
(43) Pub. Date: Oct. 15, 2026

(54) MULTI-CELL GROUP CONNECTIVITY REALIZATION MODEL FOR SECONDARY CELL GROUP (SCG) SWITCH

(71) Applicant: Apple Inc., Cupertino, CA (US)

(72) Inventors: Yuqin CHEN, Beijing (CN); Naveen Kumar R PALLE VENKATA, San Diego, CA (US); Ralf ROSSBACH, Munich (DE); Pavan NUGGEHALLI, San Carlos, CA (US); Zhibin WU, Los Altos, CA (US); Sethuraman GURUMOORTHY, San Ramon, CA (US); Alexander SIROTKIN, Petach Tikva (IL); Sarma V. VANGALA, Campbell, CA (US); Fangli XU, Beijing (CN); Haijing HU, Los Gatos, CA (US)

(73) Assignee: Apple Inc., Cupertino, CA (US)

(21) Appl. No.: 19/113,751

(22) PCT Filed: Sep. 22, 2022
(86) PCT No.: PCT/CN2022/120650

§ 371 Date: Mar. 20, 2025

(51) Int. Cl. H04W 76/27; H04W 24/10; H04W 36/00

(52) U.S. Cl. CPC H04W 76/27; H04W 24/10; H04W 36/0069

(57) ABSTRACT

Aspects are described for a user equipment (UE) comprising a transceiver configured to enable wireless communications with a base station and a processor communicatively coupled to the transceiver. The processor is configured to receive a configuration message from the base station. The configuration message includes respective radio resource control (RRC) configuration information of a plurality of secondary base stations. The processor is further configured to receive an activation message from the base station and determine at least one secondary base station of the plurality of secondary base stations based on the activation message. Finally, the processor is configured to activate a connection with the at least one secondary base station using the configuration message.

### BACKGROUND

### Field

The described aspects generally relate to a secondary cell group switch in a dual connection mode.

### SUMMARY

Some aspects of this disclosure relate to systems, apparatuses, and methods for a secondary cell group (SCG) switch in a dual connection (DC) mode. For example, the systems, the apparatuses, and the methods are provided for implementing the SCG switch by preloading RRC configuration information of multiple SCGs.

Some aspects of this disclosure relate to a base station comprising a transceiver configured to enable wireless communications with a user equipment (UE) and a processor communicatively coupled to the transceiver. The processor is configured to generate a configuration message that includes respective radio resource control (RRC) configuration information of a plurality of secondary base stations and transmit the configuration message to the UE. The processor is further configured to generate an activation message that indicates at least one secondary base station of the plurality of secondary base stations for activation and transmit the activation message to the UE.

Some aspects of this disclosure relate to a user equipment (UE) comprising a transceiver configured to enable wireless communications with a base station and a processor communicatively coupled to the transceiver. The processor is configured to receive a configuration message from the base station. The configuration message includes respective radio resource control (RRC) configuration information of a plurality of secondary base stations. The processor is further configured to receive an activation message from the base station and determine at least one secondary base station of the plurality of secondary base stations based on the activation message. The processor is further configured to activate a connection with the at least one secondary base station using the configuration message.

Some aspects of this disclosure relate to a method of operating a UE. The method comprises receiving a configuration message from a base station that includes respective radio resource control (RRC) configuration information of a plurality of secondary base stations. The method further comprises receiving an activation message from the base station; determining at least one secondary base station of the plurality of secondary base stations based on the activation message; and activating a connection with the at least one secondary base station using the configuration message.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing a DC mode for a UE, according to some aspects of the disclosure.

FIG. 2 illustrates an example system implementing an SCG switch for a UE in the DC mode, according to some aspects of the disclosure.

FIG. 3 illustrates a block diagram of an example system of an electronic device for the SCG switch implementation, according to some aspects of the disclosure.

FIG. 4 illustrates an example method of an SCG switch with on-demand RRC configuration information, according to aspects of the disclosure.

FIG. 5 illustrates an example method of an SCG switch with a preload RRC configuration information, according to aspects of the disclosure.

FIG. 6 illustrates an example system implementing a fast SCG switch, according to aspects of the disclosure.

FIG. 7 illustrates an example method of a base station performing an SCG switch, according to aspects of the disclosure.

FIG. 8 illustrates an example method of a UE performing an SCG switch, according to aspects of the disclosure.

FIG. 9 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for a secondary cell group (SCG) switch in a dual connection (DC) mode. For example, the systems, the apparatuses, and the methods are provided for implementing the SCG switch by preloading RRC configuration information of multiple SCGs.

In some aspects, a UE can enter a DC mode and connects with multiple base stations. For example, the UE can connect with a master node (MN), such as a long-term evolution (LTE) base station, and a secondary node (SN), such as a new radio (NR) base station. The MN can support a master cell group (MCG) that includes a primary cell (PCell) and one or more secondary cells (Scells). The SN can support a secondary cell group (SCG) that includes a primary secondary cell (PSCell) and one or more Scells. In some aspects, the MN and the MCG can be an anchor where the UE initiates registration and connections with the MN and the MCG. The UE can connect with the SN and the SCG via the MN and the MCG. After connecting to the MCG and the SCG, the UE can transmit and receive data via both the MCG and the SCG.

In some aspects, the UE can switch to a different SCG. For example, the UE can connect with a first SCG via a first SN. When the UE moves away from the first SN, the UE moves outside a coverage area of the first SCG and needs to connect to another SCG. In some aspects, the MN can manage the mobility of the UE and provide the UE with configuration information, such as RRC configuration information of a second SCG, to connect with the second SCG supported by a second SN. However, this process takes multiple rounds of communication. For example, the MN needs to request the configuration information from the second SN and then transmit it to the UE before the UE can initiate a connection with the second SCG. This SCG switching process can create a delay for the UE to switch between SCGs and impact the data transmission capability of the UE.

In some aspects, the UE can be preloaded with configuration information of potential SCGs to accelerate the SCG switching process. For example, the MN can transmit configuration information of a plurality of SCGs, which includes the second SCG, to the UE before the SCG switch process. When the UE moves toward the second SN, the MN can transmit an activation message to the UE to configure the UE to switch to the SCG. Because the UE already has the configuration information of the second SCG, the UE can initiate the connection with the second SCG after receiving the activation message.

In some aspects, the first SCG and the second SCG belong to a same radio link control (RLC) entity. For example, both the first SCG and the second SCG are controlled by a distribution unit (DU) base station. In such a case, the UE can reuse an RLC configuration when connecting to the first SCG to initiate the connection with the second SCG.

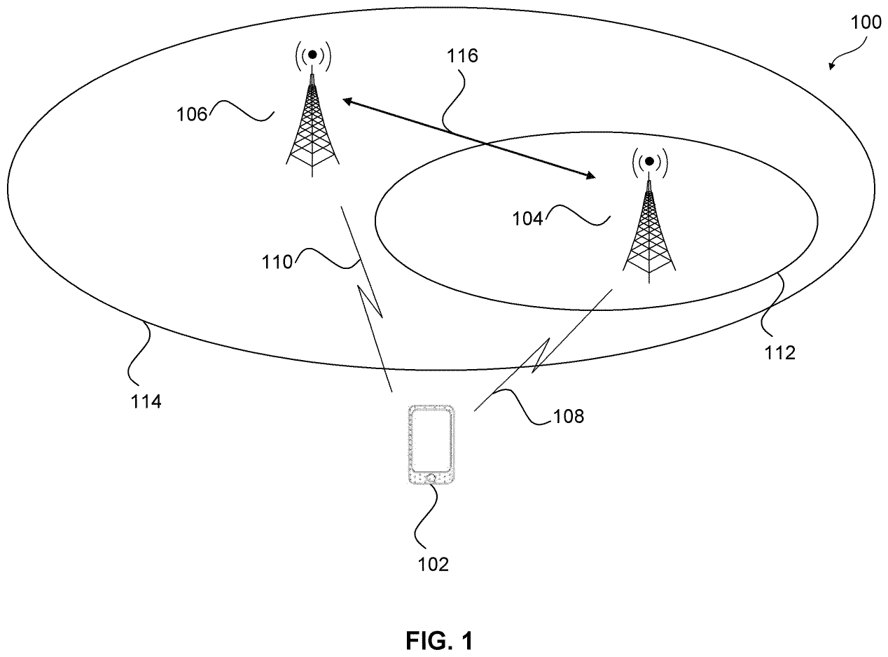

FIG. 1 illustrates an example system 100 implementing a DC mode for a UE, according to some aspects of the disclosure. The example system 100 is provided for the purpose of illustration only and does not limit the disclosed aspects. The example system 100 may include, but is not limited to, a UE 102 and base stations 104 and 106. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 can be configured to operate using one or more 3GPP releases, such as Release 15 (Rel-15), Release 16 (Rel-16), Release 17 (Rel-17), or other 3GPP releases. The UE 102 may include, but is not limited to, wireless communication devices, smartphones, laptops, desktops, tablets, personal assistants, monitors, televisions, wearable devices, Internet of Things (IoT) devices, vehicle communication devices, and the like. The base stations 104 and 106 may include one or more nodes configured to operate based on a wide variety of wireless communication techniques such as, but not limited to, techniques based on the 3GPP standards. For example, the base stations 104 and 106 may include nodes configured to operate using Rel-15, Rel-16, Rel-17, or other 3GPP releases. The base stations 104 and 106 may include, but not limited to, NodeBs, eNodeBs, gNBs, new radio base stations (NR BSs), access points (APs), remote radio heads, relay stations, and others.

In some aspects, the UE 102 connects with the base station 104 via a communication link 108 and connects with the base station 106 via a communication link 110. The base station 106 can be an MN that supports an MCG and the base station 104 can be an SN that supports an SCG. In some aspects, the base station 106 can be an anchor base station of the UE 102 that covers an area 114 and the base station 104 covers an area 112 that is smaller than the area 114. The MCG supported by the base station 106 can include multiple cells. For example, the MCG can include a PCell and one or more Scells. When the UE 102 connects with the MCG, the PCell of the MCG is active, but the one or more Scells may or may not be active. Similarly, the SCG can include a PSCell and one or more Scells. When the UE 102 connects with the SCG, the PSCell of the SCG is active, but the one or more Scells of the SCG may or may not be active. In some aspects, the UE 102 can transmit and receive data via the MCG and the SCG simultaneously. When an amount of data to be transmitted is small, the UE 102 can transmit and receive via the MCG without the SCG. However, for large data, the UE 102 can transmit and receive via both the MCG and the SCG.

In some aspects, the UE 102 can initiate connections with the SCG of the base station 104 via the base station 106. For example, the base station 106 connects with the base station 104 via a connection 116. The connection 116 can be a wired connection, such as a backhaul connection. When the UE 102 connects with the base station 106, the base station 106 can request configuration information from the base station 104 and send the configuration information to the UE 102 via the communication link 110. The UE 102 can then connect with the base station 104 based on the configuration information.

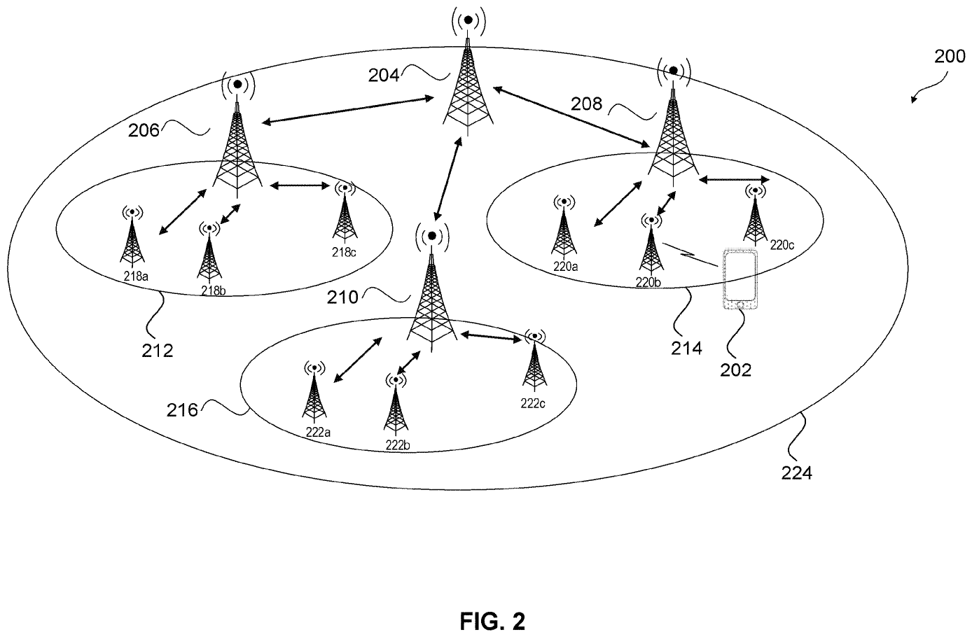

FIG. 2 illustrates an example system 200 implementing an SCG switch for a UE in the DC mode, according to some aspects of the disclosure. The example system 200 is provided for the purpose of illustration only and does not limit the disclosed aspects. The example system 200 may include, but is not limited to, a UE 202 and base stations 204, 206, 208, and 210. In some aspects, the base stations 204, 206, 208, and 210 form a hierarchy structure. For example, the base station 204 can be an MN or a centralized unit (CU) that connects with a network via wired connections. The base station 204 can also connect with the base stations 206, 208, and 210 via wired connections. The base stations 206, 208, and 210 can be distributed units (DUs). In some aspects, each DU supports one or more transmission/reception points (TRPs). The TRPs can be base stations, remote radio heads, relay stations, or others. Specifically, the base station 208 can support the TRPs 220a, 220b, and 220c that form a coverage area 214. The base station 206 can support TRPs 218a, 218b, and 218c that form a coverage area 212. The base station 210 can support the TRPs 222a, 222b, and 222c that form a coverage area 216.

In some aspects, the base station 204 can be an MN that supports an MCG. The UE 202 can be in a coverage area 224 of the base station 204 and thus can connect to the MCG via the base station 204. The TRP 220b can be an SN that supports a first SCG. The UE 202 can be in a coverage area of the TRP 220b and thus can connect to the first SCG via the TRP 220b. For example, the UE can locate in the coverage area 214. In some aspects, the UE 202 can move away from the TRP 220b and towards another TRP, such as the TRP 222c that supports a second SCG. For example, the UE can move into the coverage area 216 supported by TRPs 222a, 222b, and 222c. Because the UE 202 is still within the coverage area 224 and thus still connects to the MCG, the UE 202 can perform a switch from the first SCG of the TRP 220b to the second SCG of the TRP 222c with the assistance of the base station 204. For example, the base station 204 can send a request to the base station 210 for the configuration information of the TRP 222c. After the base station 204 receives the configuration information, the base station 204 forwards it to the UE 202 via the MCG. The UE 202 can then connect with the second SCG using the configuration information.

In some aspects, the first SCG can be supported by the base station 208. For example, the TRPs 220a, 220b, and 220c can be remote radio heads and share the first SCG. Therefore, the UE 202 can connect to the first SCG via the TRPs 220a, 220b, or 220c. In addition, switching between the TRPs 220a, 220b, and 220c does not require SCG switching. In other aspects, each TRP supports its own SCG. For example, the TRPs 220a, 220b, and 220c can be base stations and support the first SCG, a third SCG, and a fourth SCG, respectively. In such a case, the switching between the TRPs 220a, 220b, and 220c requires SCG switching.

In some aspects, the first SCG and the second SCG belong to different RLC entities. For example, the base station 208, which supports the TRP 220b, can correspond to a first RLC entity and the base station 210, which supports the TRP 222c, can correspond to a second RLC entity. In such a case, the UE 202 needs to reset the RLC configuration when connecting to the second SCG via the TRP 222c.

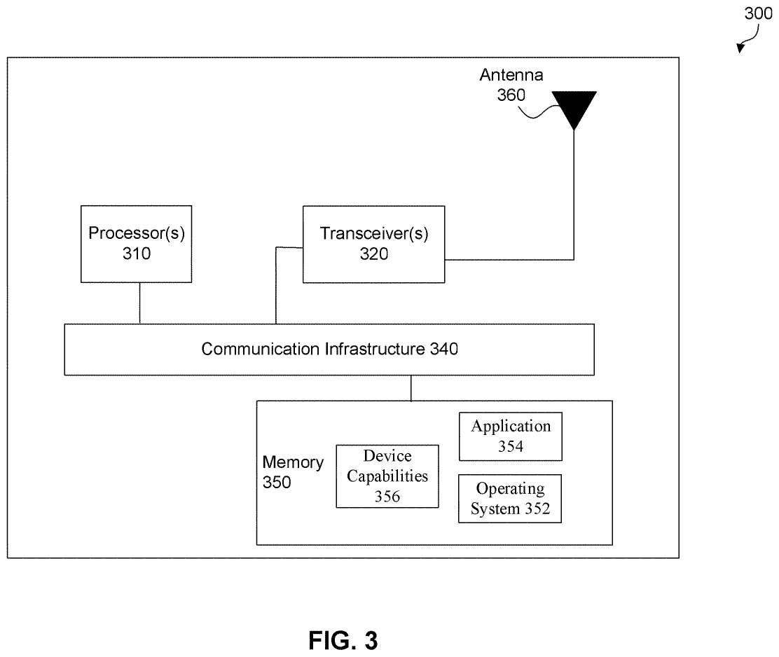

FIG. 3 illustrates a block diagram of an electronic device 300 implementing the SCG switch, according to some aspects of the disclosure. The electronic device 300 may be any of the electronic devices (e.g., the UEs 102 and 202, and the base stations 104, 106, 204, 206, 208, and 210) of the systems 100 and 200. The electronic device 300 includes a processor 310, one or more transceivers 320, a communication infrastructure 340, a memory 350, an operating system 352, an application 354, device capabilities 356, and antennas 360. Illustrated systems are provided as exemplary parts of electronic device 300, and electronic device 300 may include other circuit(s) and subsystem(s). Also, although the systems of electronic device 300 are illustrated as separate components, the aspects of this disclosure may include any combination of these, e.g., less, or more components.

The memory 350 may include random access memory (RAM) and/or cache, and may include control logic (e.g., computer software) and/or data. The memory 350 may include other storage devices or memory. According to some examples, the operating system 352 may be stored in the memory 350. The operating system 352 may manage transfer of data from the memory 350 and/or the one or more applications 354 to the processor 310 and/or the one or more transceivers 320. In some examples, the operating system 352 maintains one or more network protocol stacks (e.g., Internet protocol stack, cellular protocol stack, and the like) that may include a number of logical layers. At corresponding layers of the protocol stack, the operating system 352 includes control mechanisms and data structures to perform the functions associated with that layer.

According to some examples, the application 354 may be stored in the memory 350. The application 354 may include applications (e.g., user applications) used by the electronic device 300 and/or a user of the electronic device 300. The applications in the application 354 may include applications such as, but not limited to, radio streaming, video streaming, remote control, and/or other user applications. In some aspects, the device capabilities 356 may be stored in the memory 350.

The electronic device 300 may also include the communication infrastructure 340. The communication infrastructure 340 provides communication between, for example, the processor 310, the one or more transceivers 320, and the memory 350. In some implementations, the communication infrastructure 340 may be a bus.

The processor 310, alone, or together with instructions stored in the memory 350 performs operations enabling electronic device 300 of the systems 100 and 200 to implement the SCG switch, as described herein. Alternatively, or additionally, the processor 310 can be “hard coded” to implement mechanisms for the SCG switch, as described herein.

The one or more transceivers 320 transmit and receive communications signals support mechanisms for the SCG switch. Additionally, the one or more transceivers 320 transmit and receive communications signals that support mechanisms for measuring communication link(s), generating and transmitting system information, and receiving the system information. According to some aspects, the one or more transceivers 320 may be coupled to the antennas 360 to wirelessly transmit and receive the communication signals. The antennas 360 may include one or more antennas that may be the same or different types and can form one or more antenna ports. The one or more transceivers 320 allow electronic device 300 to communicate with other devices that may be wired and/or wireless. In some examples, the one or more transceivers 320 may include processors, controllers, radios, sockets, plugs, buffers, and like circuits/devices used for connecting to and communication on networks. According to some examples, the one or more transceivers 320 include one or more circuits to connect to and communicate on wired and/or wireless networks.

According to some aspects of this disclosure, the one or more transceivers 320 may include a cellular subsystem, a WLAN subsystem, and/or a Bluetooth subsystem, each including its own radio transceiver and protocol(s) as will be understood by those skilled in the arts based on the discussion provided herein. In some implementations, the one or more transceivers 320 may include more or fewer systems for communicating with other devices.

In some examples, the one or more the transceivers 320 may include one or more circuits (including a WLAN transceiver) to enable connection(s) and communication over WLAN networks such as, but not limited to, networks based on standards described in IEEE 802.11.

Additionally, or alternatively, the one or more the transceivers 320 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 320 may include a Bluetooth™ transceiver.

Additionally, the one or more the transceivers 320 may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the one or more transceivers 220 may be configured to operate according to one or more of Rel-15, Rel-16, Rel-17, or other releases of 3GPP standard.

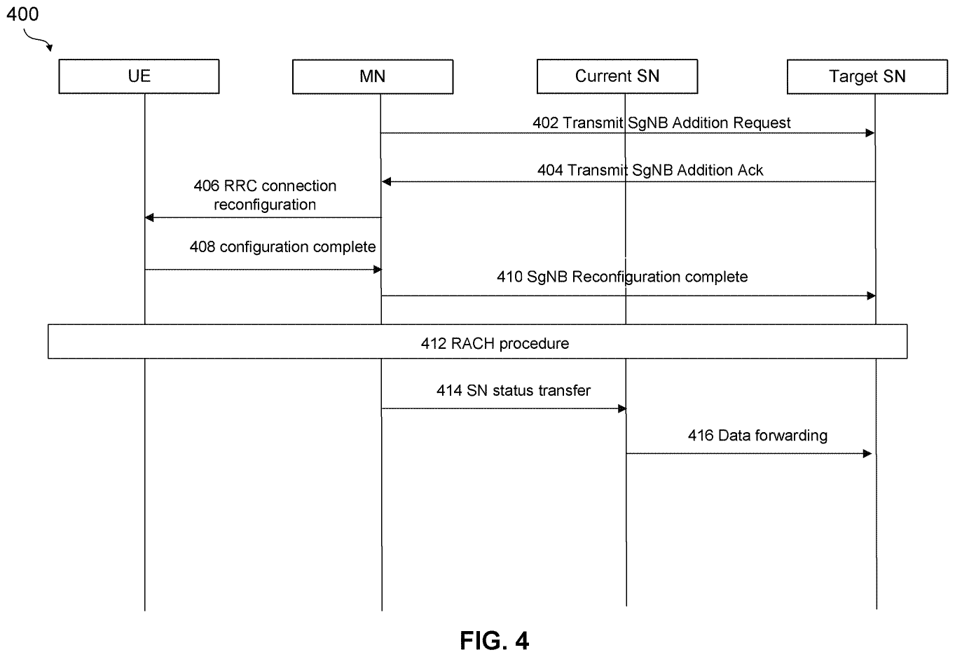

As discussed in more detail below with respect to FIGS. 4-9, processor 310 may implement different mechanisms for the SCG switch as discussed with respect to the system 100 of FIG. 1 and the system 200 of FIG. 2.

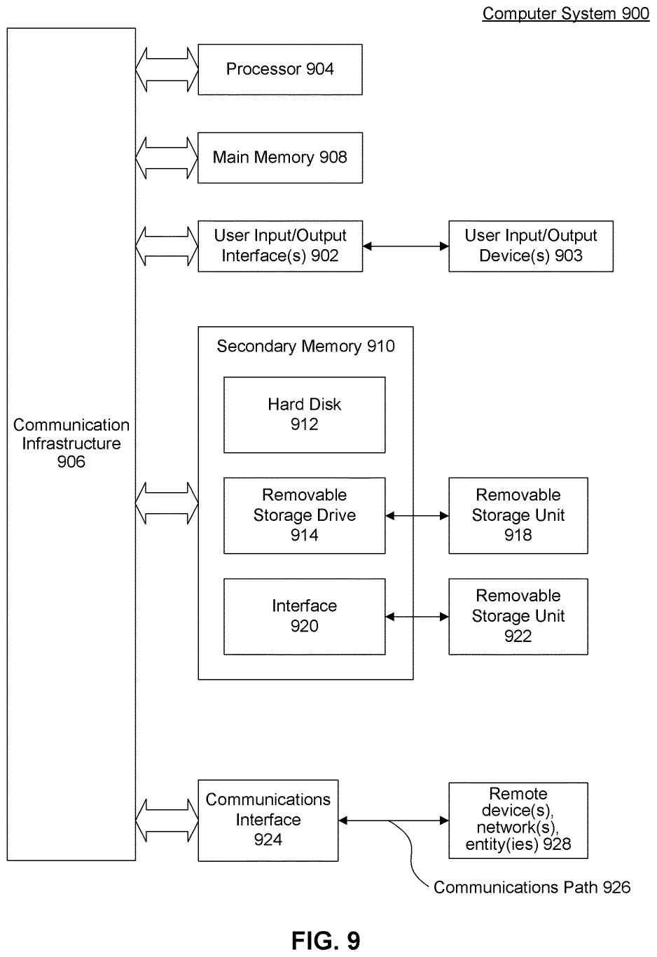

FIG. 4 illustrates an example method 400 of an SCG switch with on-demand RRC configuration information. The example method 400 is provided for the purpose of illustration only and does not limit the disclosed aspects. As a convenience and not a limitation, FIG. 4 may be described with regard to elements of FIGS. 1, 2, 3, and 9. The example method 400 may represent the operation of electronic devices (for example, the UEs 102 and 202, and the base stations 104, 106, 204, 206, 208, and 210) implementing the SCG switch. The example method 400 may also be performed by the electronic device 300 of FIG. 3, controlled or implemented by processor 310, and/or computer system 900 of FIG. 9. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, an MN, such as the base station 204, can determine that a SCG switch is required for a UE, such as the UE 202, and transmit a secondary gNodeB (SgNB) addition request to a target SN, such as the base station 210. For example, the MN can determine that the UE 202 has moved towards the TRP 222c and away from the TRP 220b. In such a case, the MN transmits the SgNB addition request to the target SN to request configuration information required to establish connections with an SCG of the target SN.

At 404, the target SN transmits a SgNB addition acknowledge message to the MN. The SgNB addition acknowledge message can include the requested configuration information, such as RRC configuration information, of the SCG of the target SN. In some aspects, the SgNB addition acknowledge message can also include resource assignment for the UE to establish connections with the SCG of the target SN.

At 406, the MN transmits a RRC connection reconfiguration message to the UE. In some aspects, the MN determines that information, such as the RRC configuration information, included in the SgNB addition acknowledge message is enough for the UE to establish connections with the SCG of the target SN. The MN can include the RRC configuration information in the RRC connection reconfiguration message and transmit it to the UE.

At 408, the UE transmits a configuration complete message to the MN. For example, the UE can confirm to connect to the SCG of the target SN and reconfigure UE setups based on the RRC connection reconfiguration message.

At 410, the MN transmits a SgNB reconfiguration complete message to the target SN to inform the target SN that the UE has completed a reconfiguration process.

At 412, the UE performs a random access channel (RACH) procedure with the target SN. For example, the UE can request resources, such as channels and time slots for uplink and downlink transmissions, from the target SN during the RACH procedure. The UE can send such a request through a RACH and the target SN can assign resources to the UE based on the request.

At 414, the MN transmits an SN status transfer message to a current SN, such as the base station 208 of FIG. 2. The SN status transfer message informs the current SN that the UE no longer connects to an SCG of the current SN and instead connects to the SCG of the target SN.

At 416, the current SN forwards data that are associated with the UE to the target SN. After that, the UE connects with the SCG of the target SN instead of the current SN.

In some aspects, because the MN transmits the SgNB addition request at 402 after determining that an SCG switch is required, the steps 402-406 may delay the UE when connecting to the SCG of the target SN. For example, the UE 202 may already be moving away from the TRP 220b and towards the TRP 222c at or before the step 402. Instead of connecting to the TRP 222c immediately, the UE 202 waits for configuration information of the TRP 222c to be received at least through steps 402-406. Therefore, the configuration information of the TRP 222c is requested by the MN, such as the base station 204, on-demand after the UE 202 moves close to the TRP 222c. In contrast, the UE 202 would be able to connect with the TRP 222c faster if the UE 202 already had the configuration information of the TRP 222c when starting to move toward the TRP 222c.

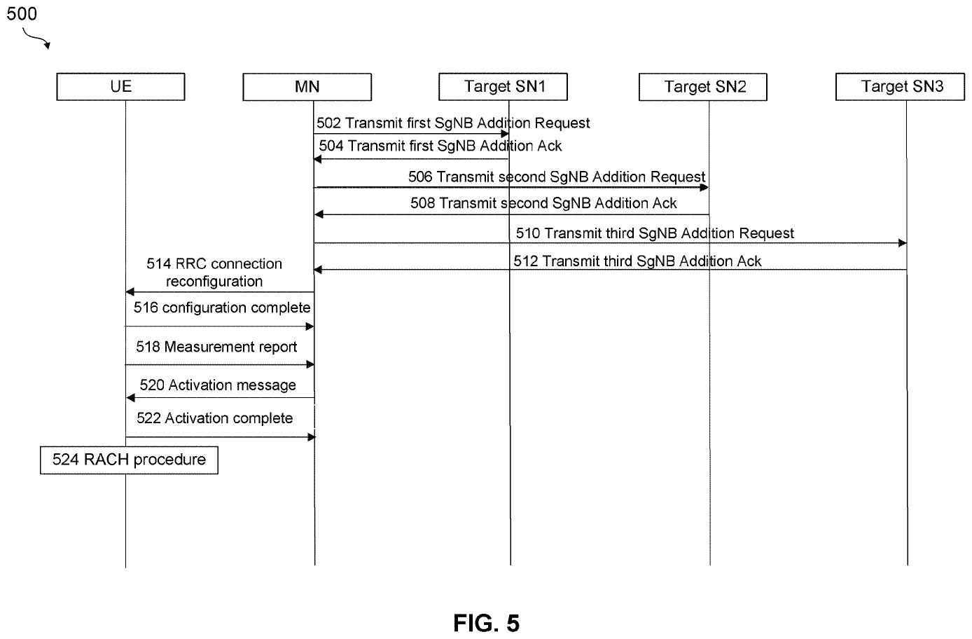

FIG. 5 illustrates an example method 500 of an SCG switch with preloaded RRC configuration information. The example method 500 is provided for the purpose of illustration only and does not limit the disclosed aspects. As a convenience and not a limitation, FIG. 5 may be described with regard to elements of FIGS. 1, 2, 3, and 9. The example method 500 may represent the operation of electronic devices (for example, the UEs 102 and 202, and the base stations 104, 106, 204, 206, 208, and 210) implementing the SCG switch. The example method 500 may also be performed by the electronic device 300 of FIG. 3, controlled or implemented by processor 310, and/or computer system 900 of FIG. 9. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, an MN can transmit a first SgNB addition request to a target SN1. Unlike in FIG. 4, a UE does not require an SCG switch at 504 and the MN transmits the first SgNB addition request for potential SCG switches.

At 504, the MN receives a first SgNB addition acknowledge message, which includes first configuration information that is required to connect to an SCG of the target SN1. The MN then stores the first configuration information in a storage of the MN.

Similarly at steps 506-512, the MN can request and obtain second and third configuration information that is required to connect to an SCG of a target SN2 and an SCG of a target SN3, respectively. The MN similarly stores the second and the third configuration information in the storage of the MN.

In some aspects, the MN can repeat steps 502-512 periodically to keep the first, the second, and the third configuration information up to date. The MN can also repeat steps 502-512 when detecting changes in a network system, such as the system 200.

At 514, the MN transmits an RRC connection reconfiguration message to the UE. The RRC connection reconfiguration message can include the first, the second, and the third configuration information obtained in steps 502-512.

At 516, the UE transmits a configuration complete message to the MN confirming that the first, the second, and the third configuration information is received.

At 518, the UE can transmit a measurement report to the MN. For example, the UE can measure signals received from the target SN1, the target SN2, and the target SN3. The UE can measure signal strengths, signal-to-noise ratio, or other metrics of the received signals.

At 520, the MN can transmit an activation message to the UE. The activation message can indicate an SCG of an SN to be connected. For example, the activation message can indicate a first SCG that is supported by the target SN1. Therefore, the activation message configures the UE to activate the first SCG and deactivate an SCG that the UE currently connects to. In some aspects, the MN can determine to activate the first SCG in different ways. First, the MN can determine based on the measurement report received at 518. Because the measurement report includes measurements of the signals received from the target SN1, the target SN2, and the target SN3, the MN can determine which SN provides a suitable SCG for the UE to connect with. For example, the MN can determine, based on the measurement report, that signals received from the target SN1 have a higher signal strength than those of the target SN2 and the target SN3. This can also indicate that the UE is located close to the target SN1 or a TRP controlled by the target SN1. In such a case, the MN can indicate the first SCG of the target SN1 in the activation message.

Second, the MN can determine which SCG to activate based on uplink signal measurements performed by SNs. For example, the target SN1, the target SN2, and the target SN3 each monitors and measures uplink signals received from the UE. The target SN1, the target SN2, and the target SN3 can each report a signal strength of signals received from the UE to the MN. Specifically, the target SN1 can report a first uplink signal measurement at 504 via the first SNB addition acknowledge message; the target SN2 can report a second uplink signal measurement at 508 via the second SNB addition acknowledge message; and the target SN3 can report a third uplink signal measurement at 512 via the third SNB addition acknowledge message. In some aspects, the target SN1, the target SN2, and the target SN3 can also report the first, the second, and the third uplink signal measurements at other times. After receiving the uplink signal measurements, the MN can select an SN with a strongest received signal. For example, the MN can determine that signals received by the target SN1 have higher strengths than those of signals received by the target SN2 or the target SN3. In such a case, the MN can determine to indicate the first SCG of the target SN1 in the activation message.

Third, the MN can determine which SCG to activate based on feedback information received from the UE. For example, the feedback information can indicate an index of a preferred SN or an index of a preferred SCG of the preferred SN. The feedback information can also include a preferred beam index of a PSCell of the preferred SCG.

In some aspects, the UE can transmit the feedback information to the MN in different ways. For example, the UE can transmit the feedback information to the MN via the configuration complete message at 516. The UE can also transmit the feedback information to the MN via the measurement report at 518. In addition, when the UE is in an RRC idle mode or an RRC inactive mode, the UE transmits an RRC resume request to the MN to switch to an RRC connected mode. The RRC resume request can also include the feedback information. Finally, the UE can transmit the feedback information to the MN via a UE assistance information message, such as a UEAssistanceInformation message.

In some aspects, the MN can transmit the activation message via an RRC message, similar to the RRC connection reconfiguration message at 514. The RRC message can indicate an SCG as well as configuration information of the SCG. For example, the activation message can indicate the first SCG of the target SN1. In some aspects, configurations of the first SCG of the target SNI have changed after the target SN1 transmits the first SgNB addition acknowledge message to the MN at 504. Therefore, the configuration information of the target SN1 received by the UE at 514 is outdated and needs an update. In such a case, the configuration information included in the activation message at 520 provides an update to the configuration information of the first SCG of the target SN1. In some aspects, the RRC message can also include network chaining counter (NCC) parameters of the first SCG of the target SNI to activate security of the first SCG.

In some aspects, the MN can transmit the activation message via a MAC CE message. The MAC CE message can include an index of an SCG, such as the first SCG of the target SN1. In such a case, the UE relies on the configuration information provided by the MN in earlier steps, such as the step 514.

At 522, the UE transmits an activation complete message to the MN. The activation complete message indicates that the UE has been reconfigured based on the configuration information indicated by the activation message. For example, the activation message can indicate the first SCG of the target SN1. The UE, after receiving the activation message, can extract the configuration information of the target SN1 received at 514 and perform reconfiguration based on the configuration information of the target SN1.

At 524, the UE performs a RACH procedure with an SN. For example, if the activation message indicates the target SN1, the UE performs the RACH procedure with the target SN1 to establish connections with the first SCG of the target SN1.

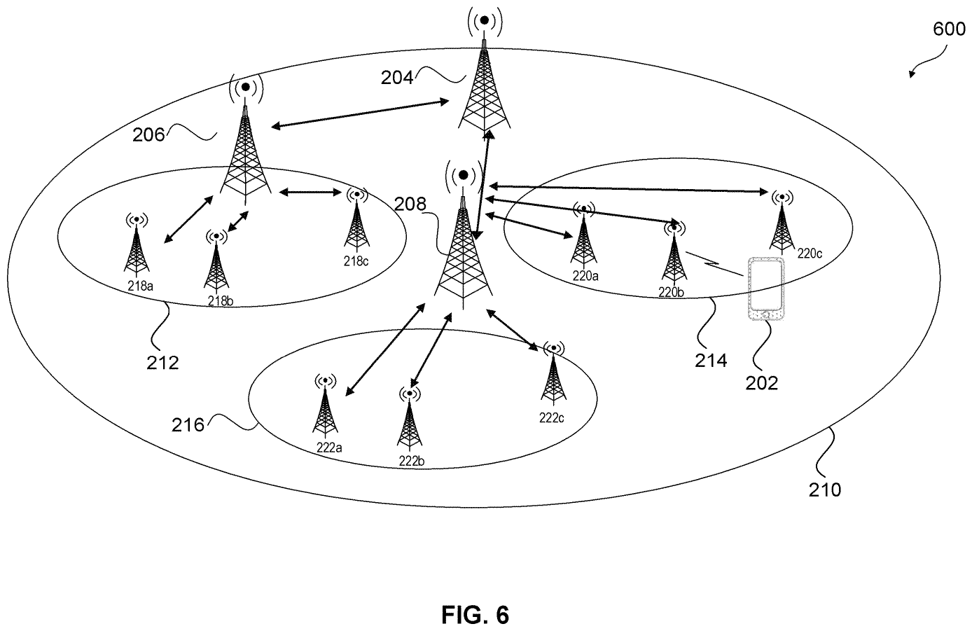

FIG. 6 illustrates an example system 600 implementing a fast SCG switch, according to some aspects of the disclosure. The example system 600 is provided for the purpose of illustration only and does not limit the disclosed aspects. The example system 600 may include, but is not limited to, a UE 202 and base stations 204, 206, and 208.

Similar to FIG. 2, the base station 204 can be an MN and the base stations 206 and 208 can be SNs. Unlike FIG. 2, TPRs 222a, 222b, 222c, 220a, 220b, and 220c are controlled by the base station 208. In some aspects, the TRPs 220a, 220b, and 220c support a first SCG. The UE 202 connects to the first SCG via the TRP 220b. Similarly, the TRPs 222a, 222b, and 222c support a second SCG. When the UE 202 moves away from the TRP 220b and towards the TRP 222c, the MN 204 configures the UE 202 to perform an SCG switch from the first SCG to the second SCG. The UE 202 can perform the SCG switch with on-demand RRC configuration information as discussed in FIG. 4 or preload RRC configuration information as discussed in FIG. 5. In either case, because the first SCG and the second SCG are controlled by a same SN, i.e., the base station 208, the first SCG and the second SCG are under a same RLC entity. In such a case, the UE 202 does not need to reset its RLC configuration when connecting to the second SCG and thus the SCG switch from the first SCG to the second SCG is a fast SCG switch. In contrast, if the UE 202 moves to the TRP 218a, the UE 202 needs to switch to a third SCG of the base station 206. Because the base station 206 and the base station 208 can belong to different RLC entities, the UE needs to reset its RLC configuration. Thus the SCG switch from the first SCG to the third SCG is a normal SCG switch.

In some aspects, the UE can determine whether the SCG switch is a fast SCG switch or a normal SCG switch based on an activation message received. For example, the activation message at 520 of FIG. 5 can include an indication of a fast SCG switch or a normal SCG switch. When the UE receives the activation message that indicates a fast SCG switch, the UE refrains from resetting its RLC configuration when connecting to a new SCG. Otherwise, the UE resets its RLC configuration when connecting to the new SCG. In some aspects, the UE can determine whether the SCG switch is a fast SCG switch without receiving an explicit indication. For example, the UE can determine that the first SCG supported by the base station 208 is the current SCG and the activation message at 520 of FIG. 5 indicates the second SCG that is also supported by the base station 208. In such a case, because the UE switches from one SCG supported by a base station to another SCG that is also supported by the same base station, the UE can determine that a fast SCG switch can be performed because it is likely that both SCGs are under a same RLC entity.

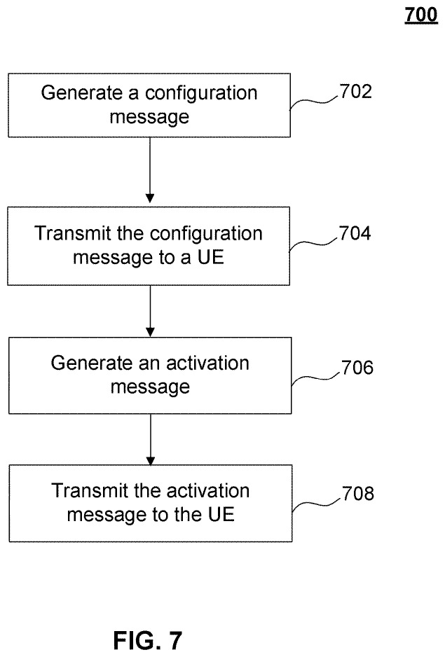

FIG. 7 illustrates an example method 700 of a base station performing an SCG switch. The example method 700 is provided for the purpose of illustration only and does not limit the disclosed aspects. As a convenience and not a limitation, FIG. 7 may be described with regard to elements of FIGS. 1, 2, 3, and 9. The example method 700 may represent the operation of electronic devices (for example, the UEs 102 and 202, and the base stations 104, 106, 204, 206, 208, and 210) implementing the SCG switch. The example method 700 may also be performed by the electronic device 300 of FIG. 3, controlled or implemented by processor 310, and/or computer system 900 of FIG. 9. But the example method 700 is not limited to the specific aspects depicted in those figures and other systems may be used to perform the method, as will be understood by those skilled in the art. It is to be appreciated that not all operations may be needed, and the operations may not be performed in the same order as shown in FIG. 7.

At 702, an MN, such as the base station 204, can generate a configuration message. The configuration message includes respective configuration information of a plurality of secondary base stations. For example, the configuration message can include RRC configuration information of the first SCG of the base station 208 and RRC configuration information of the second SCG of the base station 210.

At 704, the MN transmits the configuration message to a UE. For example, the MN can transmit an RRC connection reconfiguration message that includes the configuration message to the UE.

At 706, the MN generates an activation message. In some aspects, the activation message indicates an SCG that the UE is instructed to switch to. The MN can determine the SCG based on measurements or feedback from the UE. For example, the MN can determine which SCG or which base station supporting the SCG transmits a strongest signal based on measurement reports from the UE. Alternatively, the MN can also determine which SCG or which base station supporting the SCG receives a strongest signal from the UE based on measurement information from base stations. In addition, the UE can provide the MN with a preferred SCG. The UE can indicate the preferred SCG via a configuration complete message, a measurement report, an RRC resume request, and/or a UE assistance information message.

At 708, the MN transmits the activation message to the UE. In some aspects, the MN can transmit the activation message via an RRC message. The MN can also transmit the activation message via a MAC CE message.

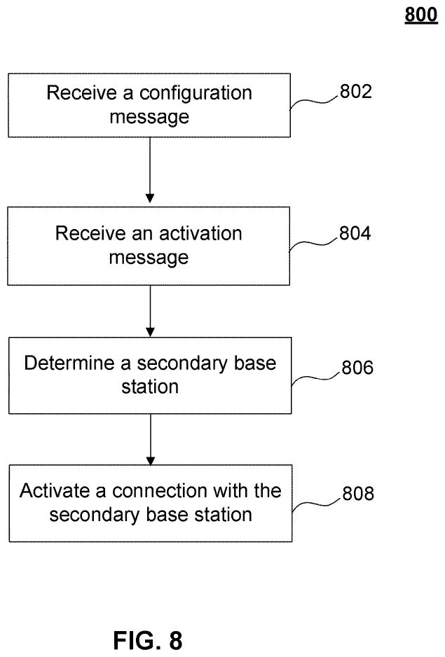

FIG. 8 illustrates an example method 800 of a UE performing an SCG switch. The example method 800 is provided for the purpose of illustration only and does not limit the disclosed aspects. As a convenience and not a limitation, FIG. 8 may be described with regard to elements of FIGS. 1, 2, 3, and 9. The example method 800 may represent the operation of electronic devices (for example, the UEs 102 and 202, and the base stations 104, 106, 204, 206, 208, and 210) implementing the SCG switch. The example method 800 may also be performed by the electronic device 300 of FIG. 3, controlled or implemented by processor 310, and/or computer system 900 of FIG. 9. But the example method 800 is not limited to the specific aspects depicted in those figures and other systems may be used to perform the method, as will be understood by those skilled in the art. It is to be appreciated that not all operations may be needed, and the operations may not be performed in the same order as shown in FIG. 8.

At 802, a UE, such as the UE 202, can receive a configuration message from a base station, such as the base station 204. The configuration message includes respective configuration information of a plurality of secondary base stations. For example, the configuration message can include RRC configuration information of the first SCG of the base station 208 and RRC configuration information of the second SCG of the base station 210.

At 804, the UE receives an activation message from the base station. The activation message indicates an SCG. For example, the activation message can include an SCG index.

At 806, the UE determines a secondary base station based on the activation message. For example, the activation message includes an SCG index corresponding to an SCG, such as the second SCG of the base station 210, as shown in FIG. 2. Therefore, the UE can determine that the activation message indicates that the base station 210 should be activated for communication.

At 808, the UE activates a connection with the secondary base station. For example, the UE can connect with the base station 210 via the second SCG. In addition, because the configuration message at 802 includes configuration information of the second SCG of the base station 210, the UE can activate the connection using the configuration information included in the configuration message.

Various aspects can be implemented, for example, using one or more computer systems, such as computer system 900 shown in FIG. 9. Computer system 900 can be any well-known computer capable of performing the functions described herein such as the UEs 102 and 202, and the base stations 104, 106, 204, 206, 208, and 210 of FIGS. 1, 2, and/or 6. Computer system 900 includes one or more processors (also called central processing units, or CPUs), such as a processor 904. Processor 904 is connected to a communication infrastructure 906 (e.g., a bus). Computer system 900 also includes user input/output device(s) 903, such as monitors, keyboards, pointing devices, etc., that communicate with communication infrastructure 906 through user input/output interface(s) 902. Computer system 900 also includes a main or primary memory 908, such as random access memory (RAM). Main memory 908 may include one or more levels of cache. Main memory 908 has stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918.

Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to some aspects, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 900, main memory 908, secondary memory 910 and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 9. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes.

Personal information from users should be collected for legitimate and reasonable uses of the entity and not shared or sold outside of those legitimate uses. Further, such collection/sharing should only occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A base station, comprising:
a transceiver configured to enable wireless communications with a user equipment (UE); and
a processor, communicatively coupled to the transceiver, and configured to:
generate a configuration message that includes respective radio resource control (RRC) configuration information of a plurality of secondary base stations;
transmit, using the transceiver, the configuration message to the UE;
generate an activation message that indicates at least one secondary base station of the plurality of secondary base stations for activation; and
transmit, using the transceiver, the activation message to the UE.

2. The base station of claim 1, wherein the processor is further configured to:
transmit, using the transceiver, a plurality of respective requests for the RRC configuration information to the plurality of secondary base stations; and
receive, using the transceiver, a plurality of respective acknowledge messages from the plurality of secondary base stations, wherein the plurality of respective acknowledge messages include the respective RRC configuration information of the plurality of secondary base stations.

3. The base station of claim 1, wherein to generate the activation message the processor is further configured to:
receive a report from the UE; and
determine the at least one secondary base station based on the report.

4. The base station of claim 3, wherein to receive the report from the UE the processor is further configured to:
receive a configuration complete message from the UE;
receive a measurement report from the UE;
receive an RRC resume request from the UE; or
receive a UE assistance information message from the UE.

5. The base station of claim 3, wherein the report from the UE includes:
respective measurement results of signals received by the UE from the plurality of secondary base stations; or
a preferred beam of a primary secondary cell (PScell) supported by the at least one secondary base station.

6. The base station of claim 1, wherein to transmit the activation message to the UE the processor is further configured to:
transmit an RRC message to the UE, wherein the RRC message includes updated RRC configuration information of the at least one secondary base station.

7. The base station of claim 1, wherein to transmit the activation message to the UE the processor is further configured to transmit a MAC control element (MAC CE) message to the UE.

8. The base station of claim 1, wherein to generate the activation message the processor is further configured to:
receive respective base station measurement reports from the plurality of secondary base stations, wherein the respective base station measurement reports are associated with uplink signals received by the plurality of secondary base stations from the UE; and
determine the at least one secondary base station based on the respective base station measurement reports.

9. The base station of claim 1, wherein the activation message configures the UE to refrain from resetting a radio link control (RLC).

10. A user equipment (UE) comprising:
a transceiver configured to enable wireless communications with a base station; and
a processor, communicatively coupled to the transceiver, and configured to:
receive, using the transceiver, a configuration message from the base station, wherein the configuration message includes respective radio resource control (RRC) configuration information of a plurality of secondary base stations;
receive, using the transceiver, an activation message from the base station;
determine at least one secondary base station of the plurality of secondary base stations based on the activation message; and
activate a connection with the at least one secondary base station using the configuration message.

11. The UE of claim 10, wherein to receive the activation message, the processor is further configured to:
receive an RRC message from the base station, wherein the RRC message includes updated RRC configuration information of the at least one secondary base station.

12. The UE of claim 10, wherein to receive the activation message, the processor is further configured to:
receive an MAC control element (MAC CE) message from the base station.

13. The UE of claim 10, wherein the processor is further configured to:
transmit a report to the base station;
wherein the report includes:
respective measurement results of signals received by the UE from the plurality of secondary base stations; or
a preferred beam of a primary secondary cell (PScell) supported by the at least one secondary base station.

14. The UE of claim 13, wherein to transmit the report to the base station the processor is further configured to:
transmit a configuration complete message to the base station;
transmit a measurement report to the base station;
transmit a RRC resume request to the base station; or
transmit a UE assistance information message to the base station.

15. The UE of claim 1, wherein the processor is further configured to:
determine to refrain from resetting a radio link control (RLC) based on the activation message.

16. The UE of claim 1, wherein the processor is further configured to:
determine a current connected secondary cell group (SCG);
determine a target SCG indicated based on the activation message;
determine that the current connected SCG and the target SCG are controlled by a radio link control (RLC) entity; and
determine to refrain from resetting a radio link control (RLC).

17. A method of a user equipment (UE) comprising:
receiving a configuration message from a base station that includes respective radio resource control (RRC) configuration information of a plurality of secondary base stations;
receiving an activation message from the base station;
determining at least one secondary base station of the plurality of secondary base stations based on the activation message; and
activating a connection with the at least one secondary base station using the configuration message.

18. The method of claim 17, further comprises:
transmitting a report to the base station,
wherein the report includes:
measurement results of signals received by the UE from the plurality of secondary base stations; or
a preferred beam of a primary secondary cell (PScell) supported by the at least one secondary base station.

19. The method of claim 17, wherein receiving the activation message the processor further comprises receiving an RRC message from the base station, wherein the RRC message includes an updated RRC configuration information of the at least one secondary base station 20. The method of claim 17, further comprising determining to refrain from resetting a radio link control (RLC) based on the activation message.
